(19) United States
(12) Patent Application Publication
(10) Pub. No.: US 2026/0170854 A1
(43) Pub. Date: Jun. 18, 2026

(54) EYE MONITORING SYSTEM FOR VEHICLE

(71) Applicant: GM Global Technology Operations LLC, Detroit, MI (US)

(72) Inventors: James Scott MacGuidwin, Northville, MI (US); Alexander Escatel, Clinton Township, MI (US); Patrick Cooke, Bloomfield Hills, MI (US)

(73) Assignee: GM Global Technology Operations LLC, Detroit, MI (US)

(21) Appl. No.: 18/980,931

(22) Filed: Dec. 13, 2024

(51) Int. Cl. G06V 20/59; G06V 40/18; H04W 4/90

(52) U.S. Cl. CPC G06V 20/597; G06V 40/18; H04W 4/90

(57) ABSTRACT

A computer-implemented method when executed by data processing hardware causes the data processing hardware to perform operations including receiving, at an eye monitoring application, eye tracking data from an imaging system, executing, via the eye monitoring application, an eye tracking protocol, the eye tracking protocol including a blink protocol and a directional protocol, comparing, via the eye tracking protocol, key points of the eye tracking data with a predefined pattern of the eye monitoring application, executing one of the blink protocol and the directional protocol based on the comparison of the key points of the eye tracking data with the predefined pattern, generating, via the eye monitoring application, an ocular emergency alert based on the executed one of the blink protocol and the directional protocol, receiving, at a back-office server, the ocular emergency alert, and generating, based on the ocular emergency alert, a confirmation notification.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a gaze monitoring system for a vehicle, and more specifically to an emergency gaze monitoring system for a vehicle.

Vehicles are often equipped with in-cabin monitoring, such as cameras, that may capture sequences of images of passengers within the vehicle. These cameras are typically used for driver monitoring and/or security purposes. Vehicles may also be equipped with a service system that a user may utilize to issue emergency messages to emergency services. For example, some service systems provide the user with the ability to place calls to emergency services. In some instances, the service system may automatically contact emergency services in the event of an emergency, such as a collision or impact, and the emergency services may place a call directly to the user via the service system of the vehicle. However, there are some scenarios where a passenger may want to contact emergency services without notifying other passengers in the vehicle. For example, if a vehicle is occupied by an unauthorized occupant, the driver or passenger may want to alert emergency services of the event without notifying the unauthorized occupant. Most vehicles utilize voice activation or collision sensors to trigger notification to emergency services. Thus, there is a need for an improved notification method to provide discrete, emergency notifications by a passenger or driver of a vehicle.

### SUMMARY

In some aspects, a computer-implemented method when executed by data processing hardware causes the data processing hardware to perform operations. The operations include receiving, at an eye monitoring application, eye tracking data from an imaging system, executing, via the eye monitoring application, an eye tracking protocol, the eye tracking protocol including a blink protocol and a directional protocol, and comparing, via the eye tracking protocol, key points of the eye tracking data with a predefined pattern of the eye monitoring application. The operations also include executing, via the eye tracking protocol, one of the blink protocol and the directional protocol based on the comparison of the key points of the eye tracking data with the predefined pattern, generating, via the eye monitoring application, an ocular emergency alert based on the executed one of the blink protocol and the directional protocol, receiving, at a back-office server, the ocular emergency alert, and generating, based on the ocular emergency alert received at the back-office server, a confirmation notification.

In some examples, generating the confirmation notification may include one or more of an icon notification, a light notification, and a haptic notification. The operations may also include calibrating, via computer vision models, the eye monitoring application based on facial landmarks. The key points of the eye tracking data may include eye coordinates. The operations may also include executing a training function of the eye monitoring application. Optionally, executing the training function may include calibrating the predefined pattern of the eye tracking protocol. The operations may further include contacting, via the back-office server, emergency services in response to the ocular emergency alert generated by the eye monitoring application. In some instances, the predefined pattern may include a blink pattern and a directional pattern.

In other aspects, an eye monitoring system includes data processing hardware and memory hardware in communication with the data processing hardware. The memory hardware stores instructions that when executed on the data processing hardware cause the data processing hardware to perform operations. The operations include receiving, at an eye monitoring application, eye tracking data from an imaging system, executing, via the eye monitoring application, an eye tracking protocol, the eye tracking protocol including a blink protocol and a directional protocol, and comparing, via the eye tracking protocol, key points of the eye tracking data with a predefined pattern of the eye monitoring application. The operations also include executing, via the eye tracking protocol, one of the blink protocol and the directional protocol based on the comparison of the key points of the eye tracking data with the predefined pattern, generating, via the eye monitoring application, an ocular emergency alert based on the executed one of the blink protocol and the directional protocol, receiving, at a back-office server, the ocular emergency alert, and generating, based on the ocular emergency alert received at the back-office server, a confirmation notification.

In some examples, generating the confirmation notification includes one or more of an icon notification, a light notification, and a haptic notification. The operations may also include calibrating, via vision models, the eye monitoring application based on facial landmarks. The key points of the eye tracking data may include eye coordinates. The operations may further include executing a training function of the eye monitoring application. Optionally, executing the training function may include calibrating the predefined pattern of the eye tracking protocol. The operations may also include contacting, via the back-office server, emergency services in response to the ocular emergency alert generated by the eye monitoring application. In some instances, the predefined pattern may include a blink pattern and a directional pattern.

In further aspects, an eye monitoring system for a vehicle includes data processing hardware and memory hardware in communication with the data processing hardware. The memory hardware stores instructions that when executed on the data processing hardware cause the data processing hardware to perform operations. The operations include receiving, at an eye monitoring application, eye tracking data from an imaging system, executing, via the eye monitoring application, an eye tracking protocol, the eye tracking protocol including a blink protocol and a directional protocol, comparing, via the eye tracking protocol, key points of the eye tracking data with a blink pattern and a directional pattern of the eye monitoring application, and executing, via the eye tracking protocol, one of the blink protocol and the directional protocol based on the comparison of the key points of the eye tracking data with the blink pattern and the directional pattern. The operations also include generating, via the eye monitoring application, an ocular emergency alert based on the executed one of the blink protocol and the directional protocol, receiving, at a back-office server, the ocular emergency alert, generating, based on the ocular emergency alert received at the back-office server, a confirmation notification, and contacting, via the back-office server, emergency services in response to the ocular emergency alert generated by the eye monitoring application.

In some examples, generating the confirmation notification may include one or more of an icon notification, a light notification, and a haptic notification. The operations may also include calibrating, via vision models, the eye monitoring application based on facial landmarks. Optionally, the key points of the eye tracking data may include eye coordinates.

### BRIEF DESCRIPTION OF THE DRAWINGS

The drawings described herein are for illustrative purposes only of selected configurations and are not intended to limit the scope of the present disclosure.

FIG. 1 is a schematic of an eye monitoring system according to the present disclosure, the eye monitoring system equipped at a vehicle and a back-office server to communicate with emergency services;

FIG. 2 is partial perspective view of an interior of a vehicle equipped with an imaging system according to the present disclosure, the imaging system capturing eye tracking data;

FIG. 3 is an exemplary block diagram of an eye monitoring system according to the present disclosure;

FIG. 4 is an exemplary flow diagram of an eye monitoring system according to the present disclosure;

FIG. 5 is another exemplary flow diagram of an eye monitoring system according to the present disclosure;

FIG. 6 is yet another exemplary flow diagram of an eye monitoring system according to the present disclosure; and

FIG. 7 is an exemplary method for an eye monitoring system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

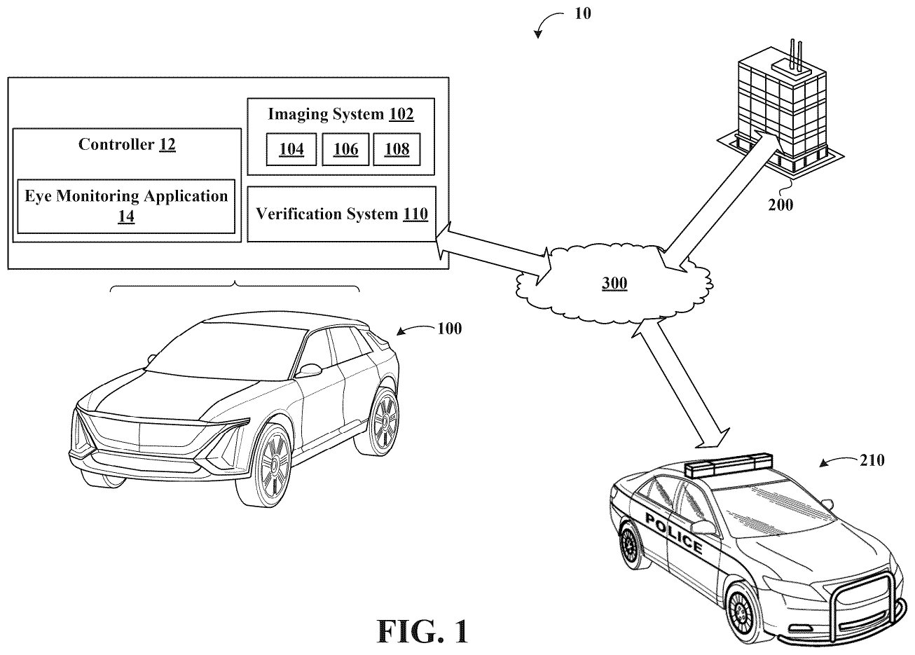

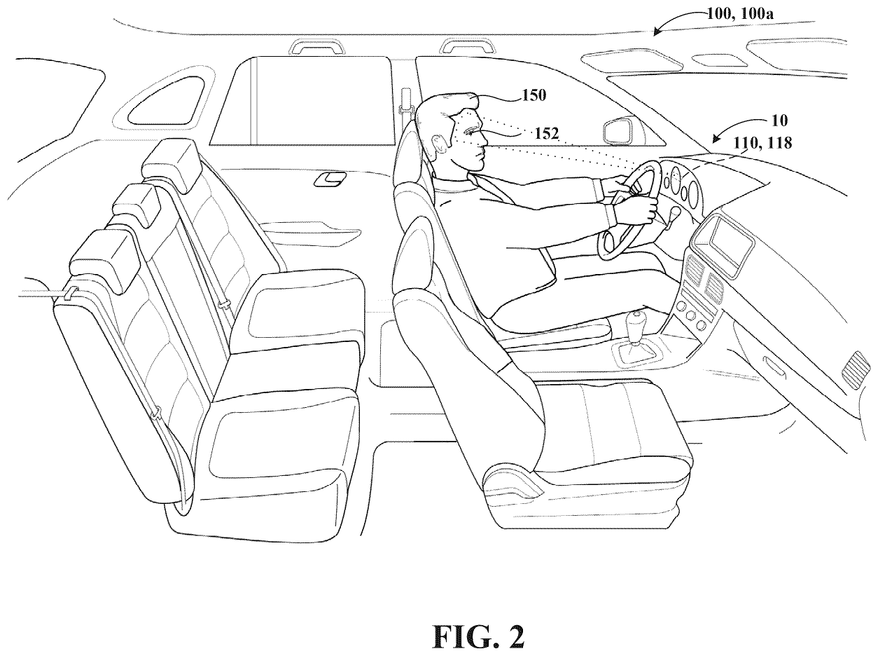

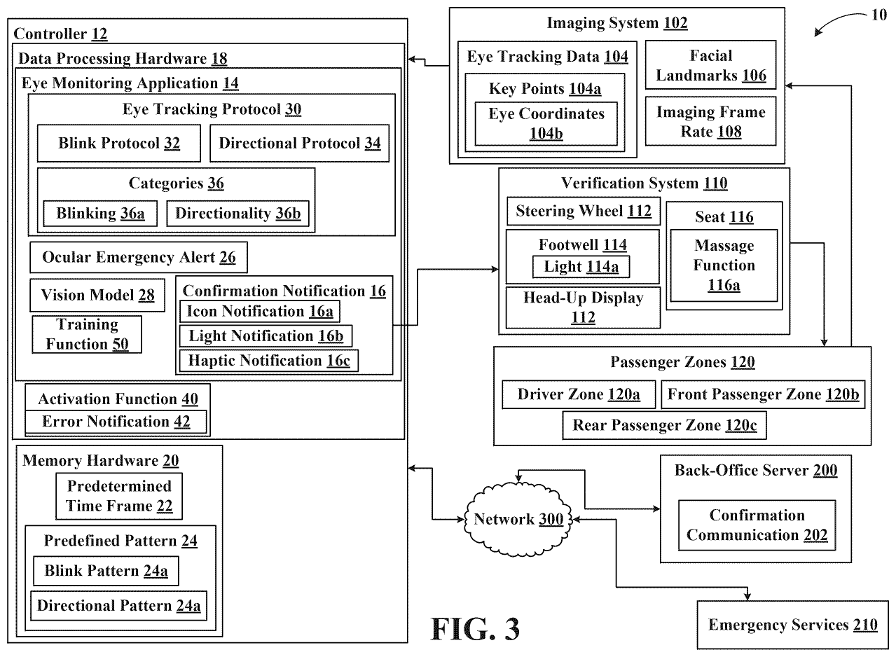

Referring to FIGS. 1-3, an eye monitoring system 10 includes a controller 12 configured with an eye monitoring application 14. The controller 12 may be configured as part of a vehicle 100 that is equipped as part of the eye monitoring system 10. The eye monitoring system 10 may also include a back-office server 200 that is in communication with the controller 12 and emergency services 210. For example, the back-office server 200 may be in communication with the controller 12 via a network 300.

The vehicle 100 may also be equipped with an imaging system 102 configured to capture eye data 104 and facial landmarks 106. The facial landmarks 106 may include, but are not limited to, facial geometry that is used by the eye monitoring application 14, as described in more detail below. The imaging system 102 also includes an imaging frame rate 108, which provides the eye monitoring application 14 with the number of frames captured by the imaging system 102. The eye monitoring system 10 utilizes both the eye tracking data 104, the facial landmarks 106, and the imaging frame rate 108 during operations, described herein.

The vehicle 100 also includes a verification system 110. The verification system 110 is configured to communicate a confirmation notification 16, described below, generated by the eye monitoring application 14. The verification system 110 may be configured with various components of the vehicle 100. For example, the verification system 110 may include a steering wheel 112, a footwell 114, a seat 116, a head-up display 118, and/or other components or systems of the vehicle 100 that may be manipulated in response to the confirmation notification 16. The example components are described with respect to the confirmation notification 16 in more detail below.

The vehicle 100 may also be divided into a plurality of passenger zones 120. The passenger zones 120 may include, but are not limited to, a driver zone 120a, a front passenger zone 120b, and a plurality of rear passenger zones 120c. The number of the plurality of rear passenger zones 120c may be dependent on the configuration of the vehicle 100 and may be customized with the eye monitoring application 14 upon initial configuration of the eye monitoring application 14. The eye monitoring application 14 is configured to distinguish eye tracking data 104 from any one or more of the plurality of passenger zones 120, 120a-c. For example, the eye monitoring application 14 is configured to differentiate between eye tracking data 104 gathered from the driver zone 120a and the rear passenger zone 120c behind the driver zone 120a. In other words, the imaging system 102 is configured to capture depths of each passenger zone 120, which may be communicated to the eye monitoring application 14 as part of the eye tracking data 104.

With further reference to FIGS. 1-3, the eye monitoring application 14 is configured to be executed by data processing hardware 18 of the controller 12. The data processing hardware 18 is in communication with memory hardware 20. The memory hardware 20 stores instructions that, when executed by the data processing hardware 18, cause the data processing hardware 18 to perform operations, described herein. The memory hardware 18 may store various setup configurations for the eye monitoring application 14. For example, the memory hardware 18 may store a predetermined time frame 22 and a predefined pattern 24. The predetermined time frame 22 is utilized by the eye monitoring application 14 to compare key points 104a of the eye tracking data 104 with the predefined pattern 24. If the key points 104a of the eye tracking data 104 match the predefined pattern 24 within the predetermined time frame 22, then the eye monitoring application 14 is configured to generate an ocular emergency alert 26, described in more detail below.

The data processing hardware 18 is configured to calibrate the eye monitoring application 14 via a vision model 28 using the facial landmarks 106 from the imaging system 102. For example, the vision model 28 is configured to extrapolate data from eye coordinates 104b of the key points 104a. While the facial landmarks 106 are utilized to calibrate the eye monitoring application 14, the facial landmarks 106 are purged by the data processing hardware 18 after calibration is completed. Further, if the eye monitoring application 14 does not trigger in response to the eye tracking data 104, then the eye tracking data 104 is purged at the end of the predetermined time frame 22. If the eye monitoring application 14 does trigger, the memory hardware 18 may store the eye tracking data 104 for a temporary duration before the eye tracking data 104 is ultimately purged.

The eye monitoring application 14 utilizes the instantaneous eye tracking data 104 and the imaging frame rate 108 to determine whether to execute an eye tracking protocol 30, described below. The imaging frame rate 108 may be utilized to configure or set the predetermined time frame 22, as the number of frames captured by the imaging system 102 directly affects the predetermined time frame 22. For example, the predetermined time frame 22 may be set to correspond to the imaging frame rate 108 to maximize the eye tracking data 104 available for use by the eye monitoring application 14.

The data processing hardware 18 may also be configured to execute an activation protocol 40. The activation protocol 40 may be a start-up function of the eye monitoring application 14 and/or may be a separate functionality of the data processing hardware 18 to verify functionality of the imaging system 102. If the imaging system 102 is not functional, then the data processing hardware 18 issues an error notification 42 at the head-up display 118 of the vehicle 100. The error notification 42 may be displayed as a service notice, such that the exact trigger of the error notification 42 (i.e., a system check of the eye monitoring application 14 and imaging system 102) remains hidden or otherwise discrete from potential third-party passengers. If the activation protocol 40 indicates the imaging system 102 and eye monitoring application 14 are functional, then the imaging system 102 begins gathering the eye tracking data 104.

Referring still to FIGS. 1-3, the eye tracking protocol 30 of the eye monitoring application 14 is configured to execute one of a blink protocol 32 and a directional protocol 34. In some instances, the eye monitoring application 14 may be configured to optionally execute both of the blink protocol 32 and the directional protocol 34 based on the key points 104a received from the imaging system 102. In other instances, the vehicle 100 may be configured with one of the blink protocol 32 or the directional protocol 34. In either configuration, both the blink protocol 32 and the directional protocol 34, if executed, result in generation of the ocular emergency alert 26. The blink protocol 32 and the directional protocol 34 are determined by the comparison of the key points 104a with the predefined pattern 24.

The key points 104a are categorized by the eye tracking protocol 30 into a series of categories 36. The categories 36 include blinking 36a and directionality 36b (i.e., left, right, center, up, and down). The eye tracking protocol 30 is configured to maintain a rolling estimation of the category 36 for each key point 104a over the predetermined time frame 22 to determine an estimation of an ocular state of a passenger 150. The categorization is performed by the eye tracking protocol 30 by executing Euclidean distance calculations, which is defined by a distance between two (2) or more points in an n-dimensional space.

The eye tracking protocol 30 compares edges of eyes 152 of a passenger 150 and an average Euclidean distance of a center of the eye 152 to the edge of the eye 152. If the average distance of both eye 152 centers is a greater magnitude than the opposite eye 152, then the eye tracking protocol 30 categorizes the directionality 36b of the key points 104a. For example, if the average center-to-left edge of each eye 152 is a factor three-times (3×) greater than a distance to a right edge, then the eye tracking protocol 30 may label the directionality 36b as a left-directionality 36b. The eye tracking protocol 30 may utilize eye coordinates 104b of the key points 104a from the edge of each eye 152 and measure the Euclidean distance between key points 104a. The distance is calculated for each eye 152 in a horizontal and vertical direction and averaged between both eyes 152 to give a factor of how open the eyes 152 are. As the eye 152 closes, the key points 104a become close together and create a strong linear correlation. For example, when the eye 152 closes, an associated openness value may range from zero (0) to three (3), while the associated openness value may range from eleven (11) to thirteen (13) when the eye 152 is open. The categories 36 are used to identify the predefined pattern 24.

The predefined pattern 24 includes a blink pattern 24a and a directional pattern 24b. The blink pattern 24a is defined by a series of rapid, successive blinks by an occupant within the predetermined time frame 22. For example, the blink pattern 24a may be configured as five (5) rapid, successive blinks captured by the imaging system 102 as eye tracking data 104 and compared with the blink pattern 24a and the predetermined time frame 22. If the eye tracking data 104 matches the blink pattern 24a within the predetermined time frame 22, then the blink protocol 32 is executed by the eye monitoring application 14.

The directional pattern 24b is defined by the key points 104a of the eye tracking data 104 corresponding to a series of directional gazes by an occupant within the predetermined time frame 22. For example, the directional pattern 24b may be configured as a sequence of gaze left, gaze center, gaze left, gaze right, and gaze right. If the eye tracking data 104 indicates that the key points 104a match or otherwise follow the directional pattern 24b within the predetermined time frame 22, then the directional protocol is executed by the eye monitoring application 14. The directional pattern 24b may be defined as a codified gaze pattern and may include a variety of different direction-based gaze patterns.

Both the blink pattern 24a and the directional pattern 24b may be configured during an initial set-up of the eye monitoring application 14. In some instances, the predefined patterns 24 may be pre-configured and instructions as to how to execute the eye tracking protocol 30 may be provided separately to the user. The eye monitoring application 14 may also be configured with a training function 50, during which a user may practice executing the eye tracking protocol 30 by completing one of the predefined patterns 24. The training function 50 may also be utilized to calibrate the predefined pattern 24 through execution by the user. The training function 50 may result in the eye monitoring application 14 generating the confirmation notification 16 for the user to verify that the user successfully triggered the eye tracking protocol 30. In a non-training function 50, the successful execution of the eye tracking protocol 30 results in the eye monitoring application 14 generating the ocular emergency alert 26.

Referring still to FIGS. 1-3, the ocular emergency alert 26 is communicated, via the network, to the back-office server 200 by the eye monitoring application 14. The back-office server 200 may send a confirmation communication 202 to the eye monitoring application 14, and the eye monitoring application 14, in response to the confirmation communication 202, executes the confirmation notification 16. In other instances, the back-office server 200 may directly execute the confirmation notification 16 via the verification system 110 of the vehicle 100. The confirmation notification 16 may include, but is not limited to, one or more of an icon notification 16a, a light notification 16b, and a haptic notification 16c. For example, the icon notification 16a may be displayed on the head-up display 118 as a service icon or other discrete icon or indicia to notify the driver or passenger 150 that the eye tracking protocol 30 has been executed and the back-office server 200 notified.

In some instances, the confirmation notification 16 may include the light notification 16b, which may be projected at one of the footwells 114 of the vehicle 100. The light notification 16b is configured to illuminate a light 114a of the footwell 114 to similarly provide assurance to the passenger 150 that the back-office server 200 has been notified by the eye monitoring application 14 in response to the eye tracking data 104 from the imaging system 102. The light notification 16b may include a light pattern, a gradual illumination, a rapid, truncated illumination, or any other practicable activation of the light 114a to discretely communicate with the passenger 150. Each footwell 114 of the vehicle 100 may be equipped with a light 114a, such that the light notification 16b may be provided to the passenger 150 regardless of which passenger zone 120 in which the passenger 150 is located.

The haptic notification 16c may be generated at one or both of the steering wheel 112 and the seat 116 of the vehicle 100. For example, if the driver was identified as the passenger 150 triggering the eye tracking protocol 30, then the confirmation notification 16 may be generated as a haptic notification 16c at the steering wheel 112. The haptic notification 16c may be a vibration of the steering wheel 112 or some other haptic pattern to notify the driver that the back-office server 200 has been notified. In other examples, the haptic notification 16c may include activation of a massage function 116a of the seat 116. As with the light notification 16b, the haptic notification 16c may be provided to the passenger 150 regardless of passenger zone 120, so long as the seat 116 is equipped with the capability to deliver the haptic notification 16c (i.e., massage function 112a and/or vibration).

The back-office server 200 is configured to contact or otherwise communicate with emergency services 210 after receiving the ocular emergency alert 26 from the eye monitoring application 14. The back-office server 200 may provide emergency services 210 with an audio and/or video stream captured by the imaging system 102 for continued monitoring of the passengers 150. The back-office server 200 may also monitor the imaging system 102 to monitor the passengers 150 in the vehicle 100. The back-office server 200 may monitor until a response is received from emergency services 210 and/or until an intervention has been achieved at the vehicle 100. The eye monitoring application 14 is configured to provide a safety feature for passengers 150 of the vehicle 100 in the event of an emergency. In some emergencies, using voice activated or voice automated systems is not feasible, such that a silent method (i.e., eye tracking) is advantageous. Thus, the eye monitoring application 14 and eye monitoring system 10, as a whole, provides an improved emergency safety mechanism for the vehicle 100 to silently capture eye tracking data 104, provide comfort to the passenger(s) 150 via the confirmation notification 16, and alert emergency services 210 of the situation in the vehicle 100.

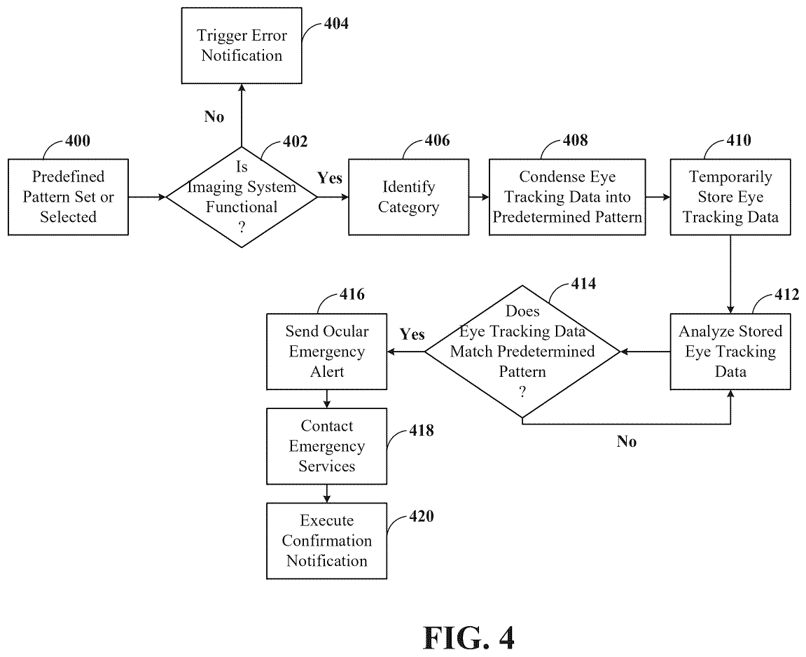

Referring to FIG. 4, an exemplary flow diagram for the eye monitoring system 10 is illustrated. At 400, a predefined pattern 24 is set and/or selected and, at 402, the imaging system 102 gathers eye tracking data 104 and facial landmarks 106. The data processing hardware 18 determines, at 404, whether the imaging system 102 is functional. If the imaging system 102 is not functional, the data processing hardware 18 triggers, at 406, the error notification 42. If the imaging system 102 is functional, the eye monitoring application 14 identifies, at 408, the respective category 36 for the eye tracking data 104. The eye monitoring application 14 condenses, at 410, the eye tracking data 104, based on the categories 36, into the predetermined pattern 24. The eye tracking data 104 is temporarily stored, at 412, by the memory hardware 20.

At 414, the eye monitoring application 14 analyzes the stored eye tracking data 104 and determines, at 416, whether the eye tracking data 104 matches the predetermined pattern 24. If not, then the eye monitoring application 14 continues to analyze the eye tracking data 104. If the eye tracking data 104 matches the predetermined pattern 24, then the eye monitoring application 14 sends, at 418, an ocular emergency alert 26 to the back-office server 200. At 420, the back-office server 200 contacts emergency services 210 and executes, at 422, the confirmation notification 16.

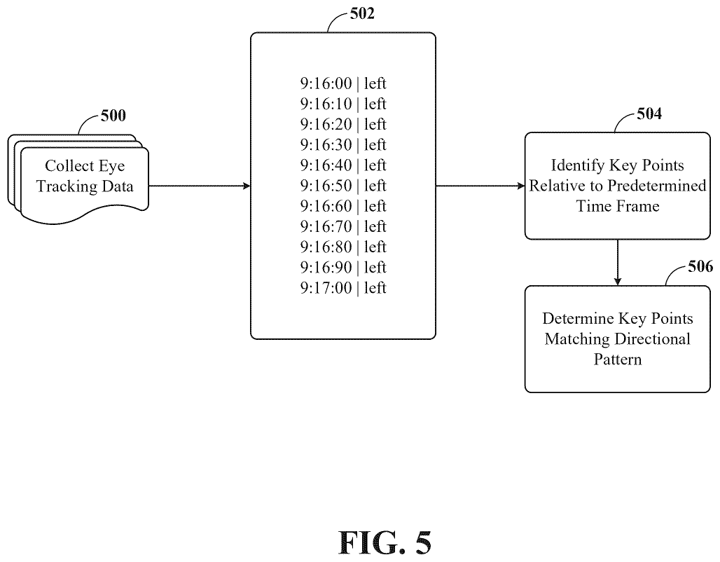

FIG. 5 illustrates an example sequence of collected eye tracking data 104 and the process by which the eye monitoring application 14 analyzes the eye tracking data 104. At 500, the eye tracking data 104 is collected. At 502, the eye tracking data 104 is presented as a series of directional key points 104a with corresponding timestamps. At 504, the eye monitoring application 14 identifies the key points 104a relative to the predetermined time frame 22 and determines, at 506, whether the key points 104a match the directional pattern 24b.

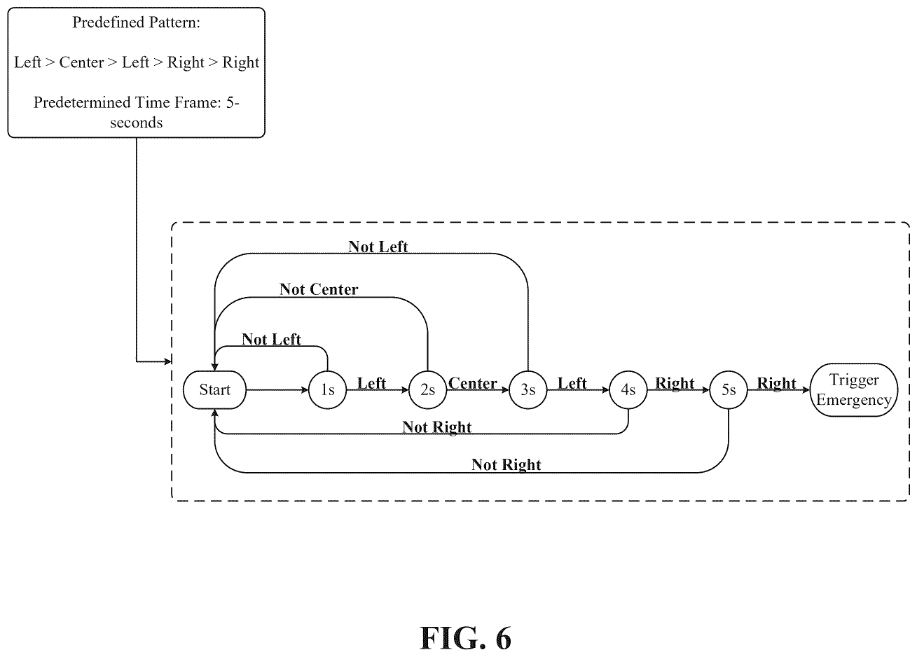

FIG. 6 similarly illustrates an example of capturing the eye tracking data 104 relative to the directional pattern 24b. In the illustrated example, the directional pattern 24b is defined as left-center-left-right-right over a five (5) second input. The eye tracking protocol 30 analyzes the key points 104a of the eye tracking data 104 over the predetermined time frame 22 of five (5) seconds. If at any given time step the key points 104a fail to match the directional pattern 24b at the corresponding time point, then the eye tracking protocol 30 resets and continues to track for the directional pattern 24b. If the key points 104a match the directional pattern 24b throughout the predetermined time frame 22, then the ocular emergency alert 26 is triggered.

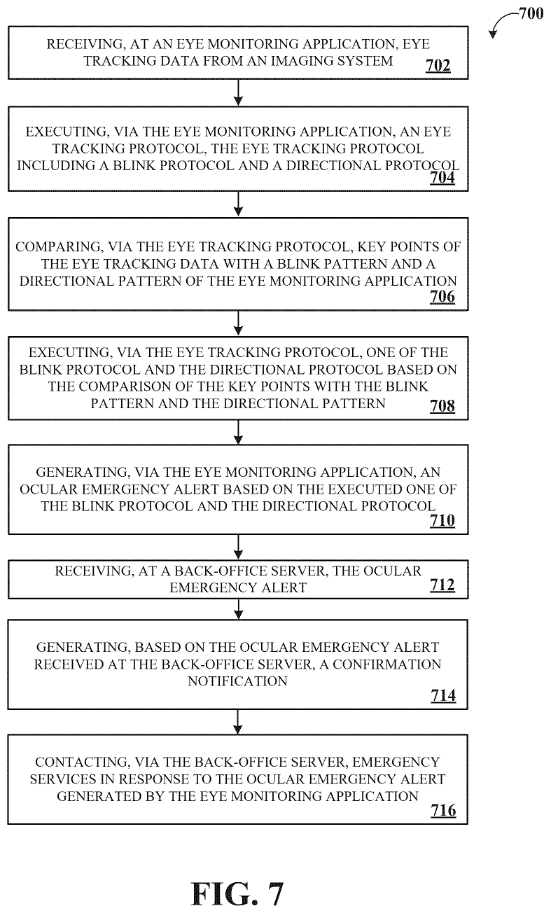

FIG. 7 illustrates an exemplary method 700 for the eye monitoring system 10. At 702, the eye monitoring application 14 receives the eye tracking data 104 from the imaging system 102. The eye monitoring application 14 executes, at 704, the eye tracking protocol 30. The eye tracking protocol 30 includes a blink protocol 32 and a directional protocol 34. The eye tracking protocol 30 compares, at 706, key points 104a of the eye tracking data 104 with a blink pattern 24a and a directional pattern 24b of the eye monitoring application 14. At 708, the eye tracking protocol 30 executes one of the blink protocol 32 and the directional protocol 34 based on the comparison of the key points 104a with the blink pattern 24a and the directional pattern 24b.

The eye monitoring application 14 generates, at 710, an ocular emergency alert 26 based on the executed one of the blink protocol 32 and the directional protocol 34. A back-office server 200 receives, at 712, the ocular emergency alert 26 and generates, at 714, based on the ocular emergency alert 26 received at the back-office server 200, a confirmation notification 16. At 716, the back-office server 200 contacts emergency services 210 in response to the ocular emergency alert 26 generated by the eye monitoring application 14.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, at an eye monitoring application, eye tracking data from an imaging system;
executing, via the eye monitoring application, an eye tracking protocol, the eye tracking protocol including a blink protocol and a directional protocol;
comparing, via the eye tracking protocol, key points of the eye tracking data with a predefined pattern of the eye monitoring application;
executing, via the eye tracking protocol, one of the blink protocol and the directional protocol based on the comparison of the key points of the eye tracking data with the predefined pattern;
generating, via the eye monitoring application, an ocular emergency alert based on the executed one of the blink protocol and the directional protocol;
receiving, at a back-office server, the ocular emergency alert; and
generating, based on the ocular emergency alert received at the back-office server, a confirmation notification.

2. The method of claim 1, wherein generating the confirmation notification includes one or more of an icon notification, a light notification, and a haptic notification.

3. The method of claim 1, further including calibrating, via computer vision models, the eye monitoring application based on facial landmarks.

4. The method of claim 1, wherein the key points of the eye tracking data include eye coordinates.

5. The method of claim 1, further including executing a training function of the eye monitoring application.

6. The method of claim 5, wherein executing the training function includes calibrating the predefined pattern of the eye tracking protocol.

7. The method of claim 1, further including contacting, via the back-office server, emergency services in response to the ocular emergency alert generated by the eye monitoring application.

8. The method of claim 1, wherein the predefined pattern includes a blink pattern and a directional pattern.

9. An eye monitoring system comprising:
data processing hardware; and
memory hardware in communication with the data processing hardware, the memory hardware storing instructions that when executed on the data processing hardware cause the data processing hardware to perform operations comprising:
receiving, at an eye monitoring application, eye tracking data from an imaging system;
executing, via the eye monitoring application, an eye tracking protocol, the eye tracking protocol including a blink protocol and a directional protocol;
comparing, via the eye tracking protocol, key points of the eye tracking data with a predefined pattern of the eye monitoring application;
executing, via the eye tracking protocol, one of the blink protocol and the directional protocol based on the comparison of the key points of the eye tracking data with the predefined pattern;
generating, via the eye monitoring application, an ocular emergency alert based on the executed one of the blink protocol and the directional protocol;
receiving, at a back-office server, the ocular emergency alert; and
generating, based on the ocular emergency alert received at the back-office server, a confirmation notification.

10. The eye monitoring system of claim 9, wherein generating the confirmation notification includes one or more of an icon notification, a light notification, and a haptic notification.

11. The eye monitoring system of claim 9, further including calibrating, via vision models, the eye monitoring application based on facial landmarks.

12. The eye monitoring system of claim 9, wherein the key points of the eye tracking data include eye coordinates.

13. The eye monitoring system of claim 9, further including executing a training function of the eye monitoring application.

14. The eye monitoring system of claim 13, wherein executing the training function includes calibrating the predefined pattern of the eye tracking protocol.

15. The eye monitoring system of claim 9, further including contacting, via the back-office server, emergency services in response to the ocular emergency alert generated by the eye monitoring application.

16. The eye monitoring system of claim 9, wherein the predefined pattern includes a blink pattern and a directional pattern.

17. An eye monitoring system for a vehicle, the eye monitoring system comprising:
data processing hardware; and
memory hardware in communication with the data processing hardware, the memory hardware storing instructions that when executed on the data processing hardware cause the data processing hardware to perform operations comprising:
receiving, at an eye monitoring application, eye tracking data from an imaging system;
executing, via the eye monitoring application, an eye tracking protocol, the eye tracking protocol including a blink protocol and a directional protocol;
comparing, via the eye tracking protocol, key points of the eye tracking data with a blink pattern and a directional pattern of the eye monitoring application;
executing, via the eye tracking protocol, one of the blink protocol and the directional protocol based on the comparison of the key points of the eye tracking data with the blink pattern and the directional pattern;
generating, via the eye monitoring application, an ocular emergency alert based on the executed one of the blink protocol and the directional protocol;
receiving, at a back-office server, the ocular emergency alert;
generating, based on the ocular emergency alert received at the back-office server, a confirmation notification; and
contacting, via the back-office server, emergency services in response to the ocular emergency alert generated by the eye monitoring application.

18. The eye monitoring system of claim 17, wherein generating the confirmation notification includes one or more of an icon notification, a light notification, and a haptic notification.

19. The eye monitoring system of claim 17, further including calibrating, via vision models, the eye monitoring application based on facial landmarks.

20. The eye monitoring system of claim 17, wherein the key points of the eye tracking data include eye coordinates.
